(19) United States
(12) Patent Application Publication
(10) Pub. No.: US 2023/0017121 A1
(43) Pub. Date: Jan. 19, 2023

(54) Bearing-Type Cradle

(71) Applicant: Ling-Chun Liao, New Taipei City (TW)

(72) Inventor: Ling-Chun Liao, New Taipei City (TW)

(21) Appl. No.: 17/375,089

(22) Filed: Jul. 14, 2021

(51) Int. Cl. A47D 9/02; H02K 33/18

(52) U.S. Cl. CPC A47D 9/02; H02K 33/18

(57) ABSTRACT

A cradle includes a base assembly, a motion assembly, and a drive device. The base assembly includes a base plate, a pressure axle seat secured on the base plate, and two pressure bearing seats secured on the base plate. The motion assembly includes a movable plate, a rotary seat secured on the movable plate and pivotally connected with the pressure axle seat, two swinging rods connected with the rotary seat, a swinging seat connected with the swinging rods, two axles mounted on the swinging seat, two rollers mounted on the axles and abutting the pressure bearing seats, and a driven member secured on the movable plate. The drive device drives the driven member, the rollers roll along the pressure bearing seats, and the movable plate swings about the pressure axle seat in a sector manner to pacify the baby.

### BACKGROUND OF THE INVENTION

### 1. Field of the Invention

The present invention relates to a bearing-type cradle for pacifying infants or babies.

### 2. Description of the Related Art

A cradle is used for placing a baby to facilitate the watcher keeping, caring, and pacifying the baby. Thus, when the baby is placed in the cradle, the parents shake the cradle to comfort the baby. However, the conventional cradle is usually operated by a manual labor, thereby wasting the watcher's energy and time. An electric or electromagnetic cradle is operated automatically to save the manual labor. The conventional electromagnetic cradle includes a power source that comes from a magnetic force between a magnet and an electromagnet. The conventional electromagnetic cradle also includes a bed pivotally mounted on a stand and arranged in a suspending manner. The bed is swinging and oscillating like a pendulum. However, the bed has a larger inertia during the swinging motion, thereby easily causing danger to the little infant or baby.

### BRIEF SUMMARY OF THE INVENTION

The primary objective of the present invention is to provide a cradle that is operated to swing slowly and safely.

In accordance with the present invention, there is provided a cradle comprising a base assembly, a motion assembly, a drive device, and a bed rail assembly. The base assembly includes a base plate, a pressure axle seat secured on a top of the base plate, and two pressure bearing seats secured on the top of the base plate. Each of the two pressure bearing seats has a top provided with a bearing face and a limit wall. The bearing face is a symmetrically arranged recessed curved face. The limit wall extends upward from the top of each of the two pressure bearing seats and defines a limit slot. The motion assembly includes a movable plate, a rotary seat secured on a bottom of the movable plate and pivotally connected with the pressure axle seat, two swinging rods connected with the rotary seat, a swinging seat connected with the two swinging rods, two axles mounted on the swinging seat, two rollers mounted on the two axles and each abutting the bearing face of each of the two pressure bearing seats respectively, two positioning members coupled to the two axles and positioning the two rollers, and at least one driven member secured on the bottom of the movable plate. Each of the two swinging rods has a first end secured to a periphery of the rotary seat and a second end secured to the swinging seat. Each of the two positioning members passes through the limit slot of each of the two pressure bearing seats. The drive device is secured on the base plate and located under the at least one driven member. The bed rail assembly is secured on the base plate.

In practice, the drive device includes an electromagnet, the at least one driven member is a permanent magnet. After the drive device is energized, the drive device produces a magnetic force to the at least one driven member, so that the rollers roll reciprocatingly along the pressure bearing seats, and the rotary seat is rotated reciprocatingly relative to the pressure axle seat, such that the movable plate swings leftward and rightward about the pressure axle seat in a sector manner to pacify the baby.

According to the primary advantage of the present invention, the pressure axle seat and the pressure bearing seats support the weight of the motion assembly, so that the rollers roll reciprocatingly along the pressure bearing seats, and the movable plate swings leftward and rightward about the pressure axle seat in a sector. In such a manner, the movable plate swings leftward and rightward in a sector manner so that the two ends of the movable plate have different swing or amplitude of oscillation. Thus, the baby is placed on the movable plate with the baby's head being close to the pressure axle seat having a less swing to reduce the swinging action of the baby's head, and to prevent the baby's head from being damaged due to a large swinging action. In addition, the baby's head is distant from the at least one driven member and the drive device to prevent the baby from being affected by unknown effects caused by the at least one driven member and the drive device.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a cradle in accordance with the preferred embodiment of the present invention.

FIG. 2 is a partial cross-sectional view of the cradle in accordance with the preferred embodiment of the present invention.

FIG. 3 is a perspective view of a pressure bearing seat of the cradle in to accordance with the preferred embodiment of the present invention.

FIG. 4 is a partial perspective view of a motion assembly of the cradle in accordance with the preferred embodiment of the present invention.

FIG. 5 is an exploded perspective view of a drive device of the cradle in accordance with the preferred embodiment of the present invention.

FIG. 6 is a schematic operational view of the cradle in accordance with the preferred embodiment of the present invention.

FIG. 7 is a cross-sectional operational view showing rolling of a roller.

FIG. 8 is an exploded perspective view of a cradle with a support rack in accordance with the preferred embodiment of the present invention.

FIG. 9 is a partial perspective view of the cradle as shown in FIG. 8.

FIG. 10 is a partial cross-sectional assembly view of the cradle as shown in FIG. 8.

FIG. 11 is a perspective view of a cradle in accordance with the second preferred embodiment of the present invention.

FIG. 12 is a partial exploded perspective view of the cradle as shown in FIG. 11.

FIG. 13 is a partial cross-sectional assembly view of the cradle as shown in FIG. 11.

FIG. 14 is a schematic operational view of the cradle as shown in FIG.

### DETAILED DESCRIPTION OF THE INVENTION

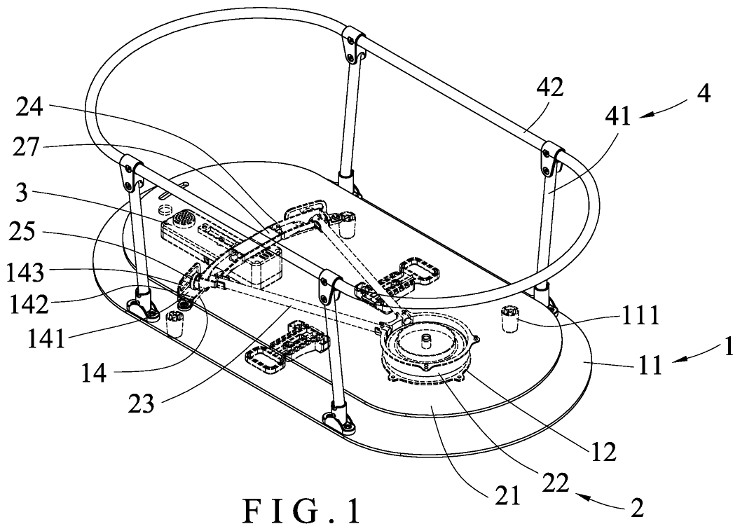

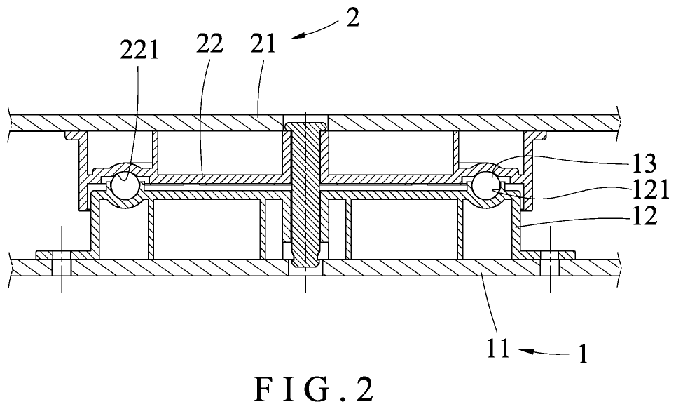

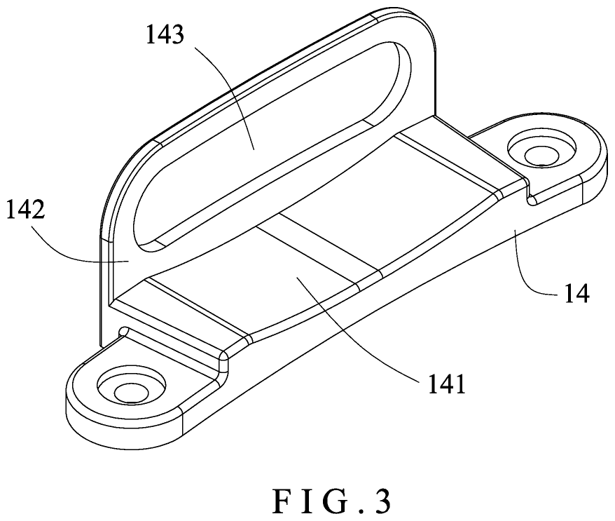

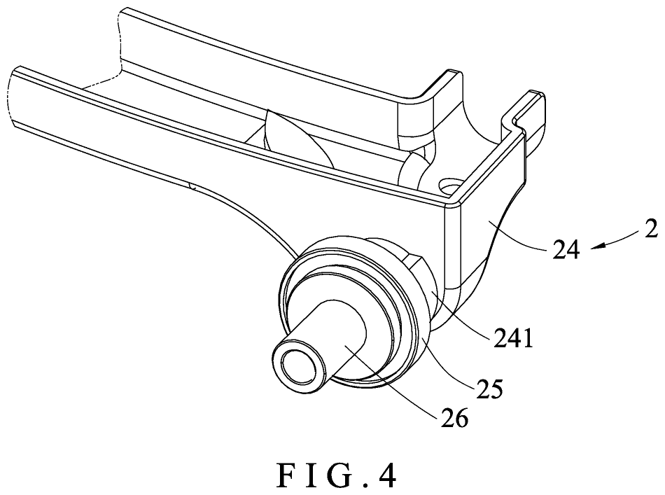

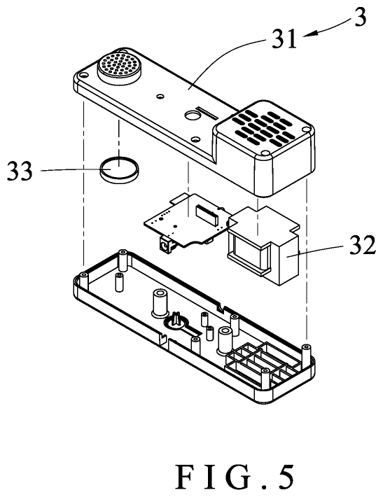

Referring to the drawings and initially to FIGS. 1-5, a cradle in accordance with the preferred embodiment of the present invention comprises a base assembly 1, a motion assembly 2, a drive device 3, and a bed rail (or fence) assembly 4.

The base assembly 1 includes a base plate 11, a plurality of pads 111 secured on a bottom of the base plate 11, a pressure axle seat 12 secured on a top of the base plate 11, a plurality of rolling balls 13 mounted on the pressure axle seat 12, and two pressure bearing seats 14 secured on the top of the base plate 11. The pressure axle seat 12 has a top provided with a plurality of ball holes 121 arranged in an annular shape. The rolling balls 13 are mounted in the ball holes 121. Each of the two pressure bearing seats 14 has a top provided with a bearing face 141 and a limit wall 142. The bearing face 141 is a symmetrically arranged recessed curved face having a middle and two sides higher than the middle so that the bearing face 141 has a height gradually reduced from the two sides toward the middle thereof. The limit wall 142 extends upward from the top of each of the two pressure bearing seats 14 and defines a limit slot 143.

The motion assembly 2 includes a movable plate 21 swingable relative to the base plate 11, a rotary seat 22 secured on a bottom of the movable plate 21 and pivotally connected with the pressure axle seat 12, two swinging rods 23 connected with the rotary seat 22, a swinging seat 24 connected with the two swinging rods 23, two axles 241 mounted on the swinging seat 24, two rollers 25 mounted on the two axles 241 and each abutting the bearing face 141 of each of the two pressure bearing seats 14 respectively, two positioning members 26 coupled to the two axles 241 and positioning the two rollers 25, and two driven members 27 secured on the bottom of the movable plate 21. The rotary seat 22 has a bottom provided with a slideway 221 abutting the rolling balls 13 which are mounted between the ball holes 121 and the slideway 221. Each of the two swinging rods 23 has a first end secured to a periphery of the rotary seat 22 and a second end secured to the swinging seat 24. Each of the two positioning members 26 passes through the limit slot 143 of each of the two pressure bearing seats 14.

The drive device 3 is secured on the base plate 11 and includes a housing 31, a power generator 32 mounted in the housing 31, and a control module 33 mounted in the housing 31 and electrically connected with the power generator 32. The power generator 32 is located under and correspond to the two driven members 27. The power generator 32 provides a force to drive the two driven members 27.

The bed rail assembly 4 includes a plurality of upright posts 41 secured on the base plate 11, and an enclosure frame 42 connected with the upright posts 41.

In practice, each of the two rollers 25 of the motion assembly 2 is arranged on the bearing face 141 of each of the two pressure bearing seats 14, so that when each of the two rollers 25 is situated at the two sides of the bearing face 141, each of the two rollers 25 is rolled toward the middle of the bearing face 141 automatically. The power generator 32 of the drive device 3 provides a force to drive the two driven members 27, so that the two driven members 27 drive the movable plate 21 to swing.

In the preferred embodiment of the present invention, each of the two driven members 27 is a permanent magnet secured in the swinging seat 24 which is secured to the movable plate 21. The power generator 32 of the drive device 3 is an electromagnet that attracts or repels each of the two driven members 27. The control module 33 of the drive device 3 controls the power generator 32 to produce an electromagnetic force of different modes. For example, the control module 33 of the drive device 3 controls the power generator 32 to produce magnetism in a regularly intermittent manner. In the preferred embodiment of the present invention, the power generator 32 keeps the magnetism during one second and stops the magnetism during one second, and the process is repeated successively. Alternatively, the N pole and S pole of the power generator 32 are inverted repeatedly to produce the magnetism. Alternatively, the control module 33 of the drive device 3 contains a magnetic detector or sensor that detects the relative position and the movement direction of the two driven members 27, so that the power generator 32 is controlled by the control module 33 to produce a magnetically attractive force when the two driven members 27 approach, and produce a magnetically repulsive force when the two driven members 27 leave.

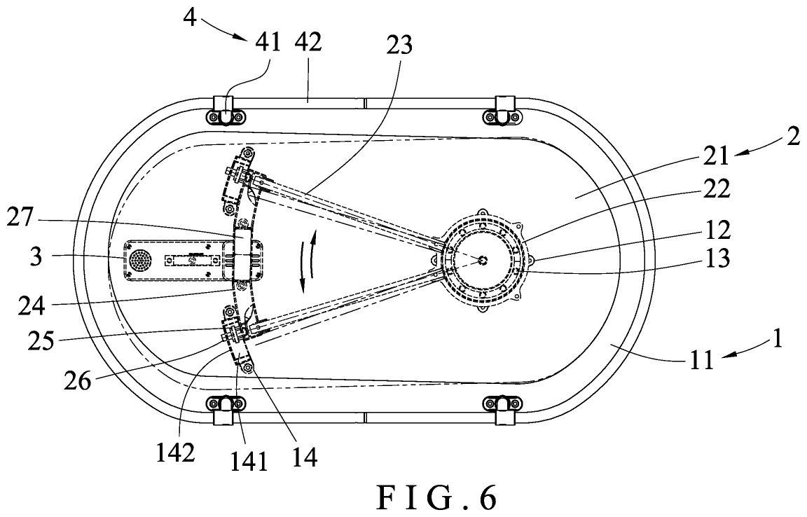

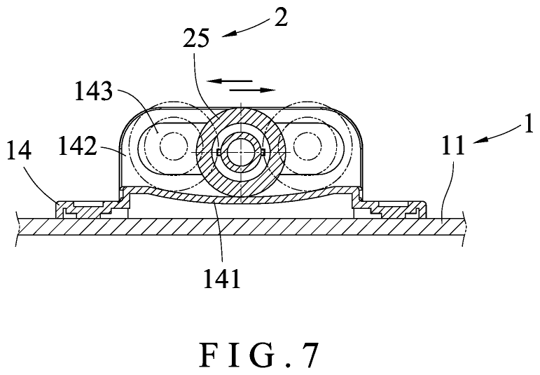

In operation, referring to FIGS. 6 and 7 with reference to FIGS. 1-5, when each of the two rollers 25 is situated at the two sides of the bearing face 141, each of the two rollers 25 is rolled toward the middle of the bearing face 141 automatically. In addition, the control module 33 controls the power generator 32 to attract or repel the two driven members 27. In such a manner, the movable plate 21 is driven by the two driven members 27 to swing reciprocatingly. When the movable plate 21 swings, each of the two rollers 25 is rolled along the bearing face 141 reciprocatingly, and the rotary seat 22 is rotated relative to the pressure axle seat 12 reciprocatingly, so that the movable plate 21 is moved relative to the base plate 11 leftward and rightward in a sector (or fan) manner. Thus, when the baby is placed on the movable plate 21, the movable plate 21 swings reciprocatingly to pacify the baby. As shown in FIG. 6, the movable plate 21 swings leftward and rightward in a sector manner so that the two ends of the movable plate 21 have different swing or amplitude of oscillation. Thus, the baby is placed on the movable plate 21 with the baby's head being close to the pressure axle seat 12 having a less swing to reduce the swinging action of the baby's head, and to prevent the baby's head from being damaged due to a large swinging action. In addition, the baby's head is distant from the two driven members 27 and the drive device 3 to prevent the baby from being affected by unknown effects caused by the two driven members 27 and the drive device 3.

Referring to FIGS. 1-4, each of the pads 111 is made of rubber with anti-skid and vibration-proof effects so that when the movable plate 21 swings, the base plate 11 is kept in place by the pads 111. In addition, the rolling balls 13 is arranged between the pressure axle seat 12 and the rotary seat 22, so that the rotary seat 22 is rotated smoothly. Further, each of the two positioning members 26 passes through the limit slot 143 of each of the two pressure bearing seats 14 to limit the swing of the movable plate 21.

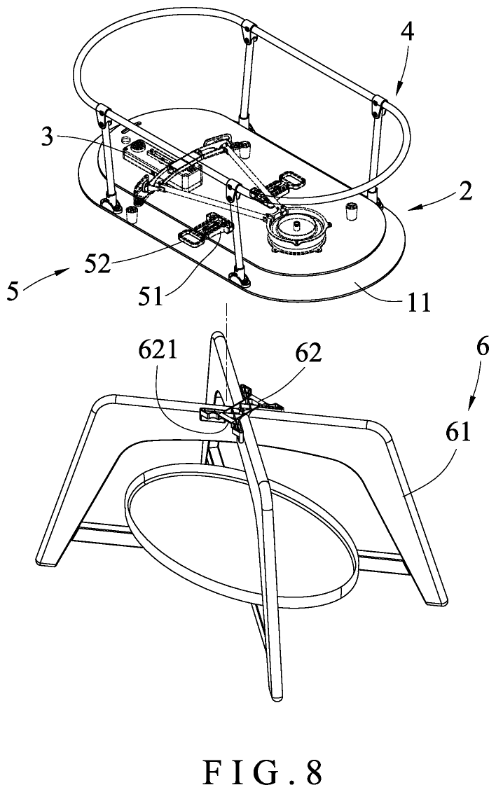

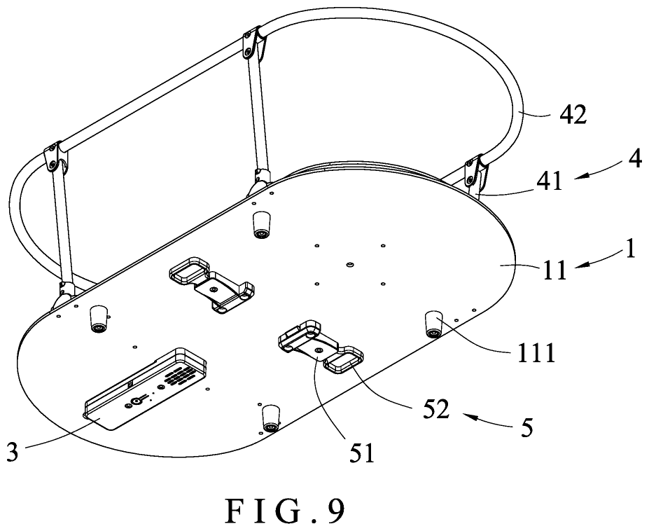

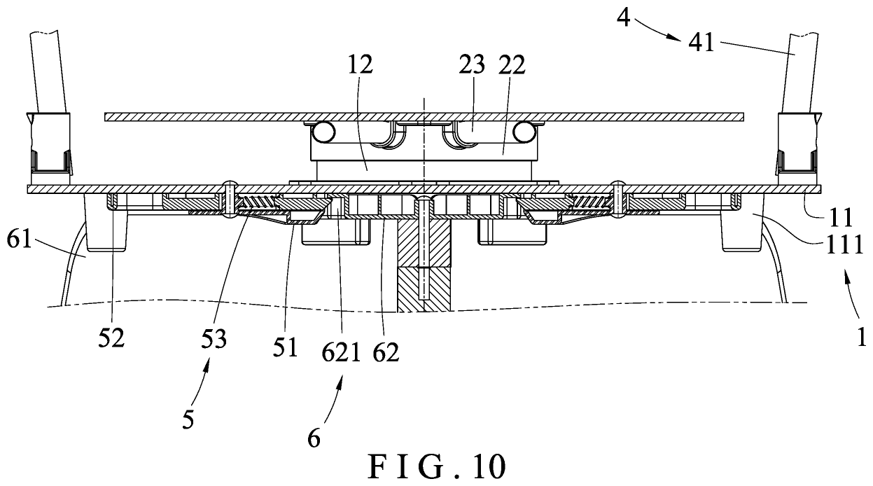

Referring to FIGS. 8-10, the cradle further comprises a support rack 6 and at least one coupling set 5 mounted on the bottom of the base plate 11 and coupled to the support rack 6 to increase the height of the cradle. In the preferred embodiment of the present invention, the at least one coupling set 5 includes two guide seats 51 secured on the bottom of the base plate 11, two locking handles 52 movably mounted on the two guide seats 51 respectively, and two springs 53 biased between the two guide seats 51 and the two locking handles 52. The support rack 6 includes a stand 61 and a locking seat 62 secured on a top of the stand 61. The locking seat 62 has two locking grooves 621 formed on two sides thereof. In assembly, the two locking handles 52 are pulled outward. Then, the base plate 11 is placed on the support rack 6, with the locking seat 62 being located between the two guide seats 51, and with the two locking handles 52 aligning with the two locking grooves 621 of the locking seat 62 respectively. After the two locking handles 52 are released, the two locking handles 52 are pushed toward the locking seat 62 by the restoring force of the two springs 53, so that one end of each of the two locking handles 52 is locked into each of the two locking grooves 621 of the locking seat 62. Thus, the at least one coupling set 5 is locked onto the support rack 6. When the two locking handles 52 are pulled outward again, each of the two locking handles 52 is detached from each of the two locking grooves 621 of the locking seat 62, so that the at least one coupling set 5 is unlocked from the support rack 6.

In the preferred embodiment of the present invention, the cradle is driven to swing by an electromagnetic force.

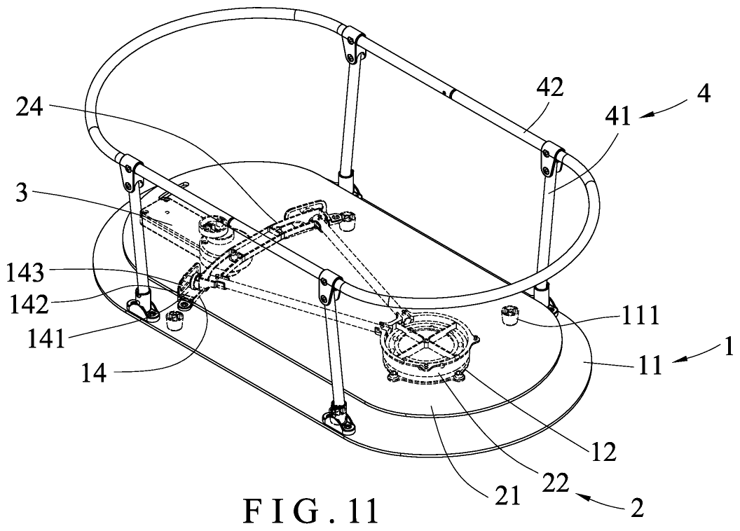

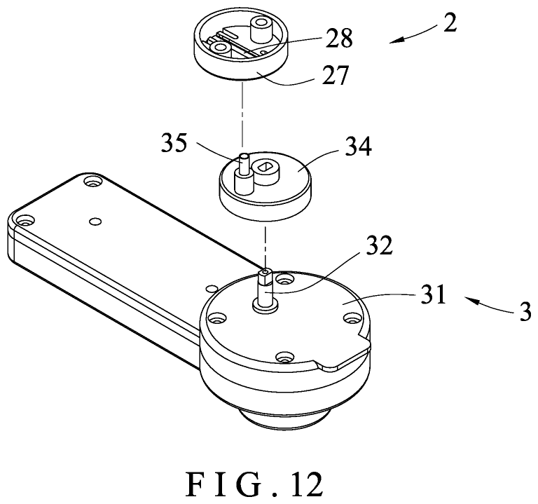

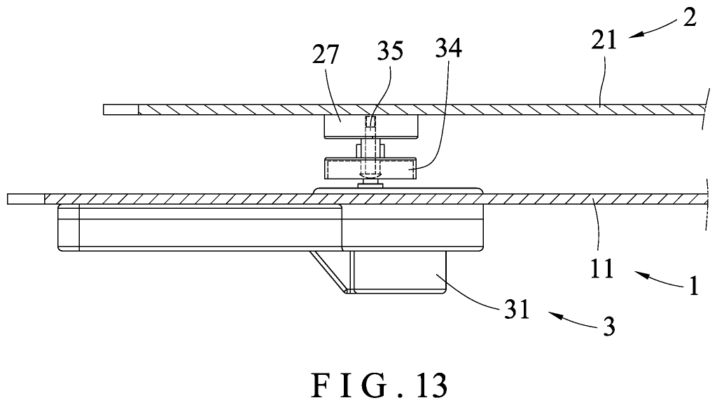

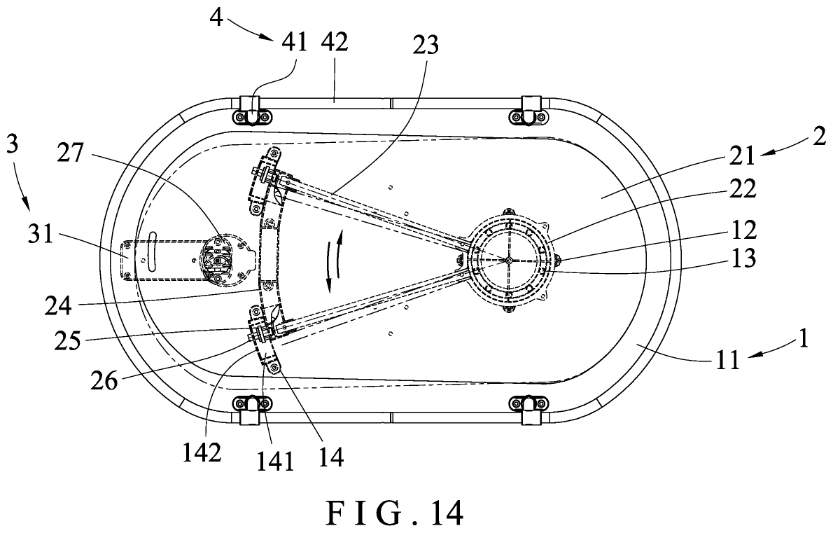

Referring to FIGS. 11-14, the drive device 3 includes a motor driving the power generator 32, a rotation wheel 34 secured on a rotation shaft of the power generator 32, and a rod-shaped guide shaft 35 secured to and located at an eccentric position of the rotation wheel 34. The motion assembly 2 includes a driven member 27 secured on the bottom of the movable plate 21. The driven member 27 is provided with a guide slot 28 having a linear shape and a predetermined length. The guide shaft 35 is inserted into the guide slot 28.

In operation, when the power generator 32 rotates the rotation wheel 34 constantly, the guide shaft 35 is rotated with the rotation wheel 34. At this time, the guide shaft 35 pushes the edge of the guide slot 28 successively so that the driven member 27 and the movable plate 21 are driven by the guide shaft 35 to swing successively in a sector manner. In such a manner, the guide shaft 35 is rotated successively, and the driven member 27 swings successively, so that it looks like the guide shaft 35 is moved in the guide slot 28 reciprocatingly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A cradle comprising:
a base assembly, a motion assembly, a drive device, and a bed rail assembly;
wherein:
the base assembly includes a base plate, a pressure axle seat secured on a top of the base plate, and two pressure bearing seats secured on the top of the base plate;
each of the two pressure bearing seats has a top provided with a bearing face and a limit wall;
the bearing face is a symmetrically arranged recessed curved face;
the limit wall extends upward from the top of each of the two pressure bearing seats and defines a limit slot;
the motion assembly includes a movable plate, a rotary seat secured on a bottom of the movable plate and pivotally connected with the pressure axle seat, two swinging rods connected with the rotary seat, a swinging seat connected with the two swinging rods, two axles mounted on the swinging seat, two rollers mounted on the two axles and each abutting the bearing face of each of the two pressure bearing seats respectively, two positioning members coupled to the two axles and positioning the two rollers, and at least one driven member secured on the bottom of the movable plate;
each of the two swinging rods has a first end secured to a periphery of the rotary seat and a second end secured to the swinging seat;
each of the two positioning members passes through the limit slot of each of the two pressure bearing seats;
the drive device is secured on the base plate and located under the at least one driven member; and
the bed rail assembly is secured on the base plate.

2. The cradle as claimed in claim 1, wherein the base assembly further includes a plurality of pads secured on a bottom of the base plate.

3. The cradle as claimed in claim 1, wherein the base assembly further includes a plurality of rolling balls mounted on the pressure axle seat, the pressure axle seat has a top provided with a plurality of ball holes arranged in an annular shape, the rolling balls are mounted in the ball holes, and the rotary seat has a bottom provided with a slideway abutting the rolling balls.

4. The cradle as claimed in claim 1, further comprising:
a support rack; and
at least one coupling set mounted on the bottom of the base plate and coupled to the support rack.

5. The cradle as claimed in claim 4, wherein the at least one coupling set includes two guide seats secured on the bottom of the base plate, two locking handles movably mounted on the two guide seats respectively, and two springs biased between the two guide seats and the two locking handles, the support rack includes a stand and a locking seat secured on a top of the stand, the locking seat has two locking grooves formed on two sides thereof, and each of the two locking handles of the at least one coupling set is locked into each of the two locking grooves of the locking seat.

6. The cradle as claimed in claim 1, wherein the at least one driven member is a permanent magnet secured in the swinging seat, the drive device includes a housing, a power generator mounted in the housing, and a control module mounted in the housing and electrically connected with the power generator, the power generator is located under and correspond to the at least one driven member, and the power generator of the drive device is an electromagnet.

7. The cradle as claimed in claim 1, wherein the drive device includes a housing, a power generator mounted in the housing, a motor driving the power generator, a rotation wheel secured on the power generator, and a rod-shaped guide shaft secured to and located at an eccentric position of the rotation wheel, the at least one driven member is secured on the bottom of the movable plate, the driven member is provided with a guide slot having a linear shape, and the guide shaft is inserted into the guide slot.
